(19) United States
(12) Patent Application Publication
(10) Pub. No.: US 2008/0244492 A1
(43) Pub. Date: Oct. 2, 2008

(54) APPARATUS AND METHOD FOR DESIGNING SYSTEM, AND COMPUTER READABLE MEDIUM

(75) Inventor: Takeo Imai, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/048,503

(22) Filed: Mar. 14, 2008

(30) Foreign Application Priority Data
Mar. 28, 2007 (JP) 2007-84639

(51) Int. Cl. G06F 17/50

(52) U.S. Cl. 716/10

(57) ABSTRACT

There is provided with a designing apparatus, including: an input accepting unit configured to accept an input of design description which describes a design of a system that includes components and a plurality of channels each of which connects between components communicating with each other; component constraint description which describes constraints that should be met by respective components; channel constraint description which describes constraints that should be met by respective channels; a connection constraint description calculator configured to calculate connection constraint description which describes constraints that should be met between components connected by each channel: a specifying unit configured to specify communication medium or communication protocol to be used in the system; an overall constraint description calculator configured to calculate overall constraint description which describes constraints that should be met between all of the components.

### CROSS REFERENCE TO RELATED APPLICATIONS

This application is based upon and claims the benefit of priority from the prior Japanese Patent Applications No. 2007-84639, filed on Mar. 28, 2007; the entire contents of which are incorporated herein by reference.

### BACKGROUND OF THE INVENTION

1. Field of the Invention

The present invention relates to a designing apparatus and designing method for designing a system that is mainly composed of electronic circuits, such as design of Large Scale Integration (LSI), and a computer readable medium storing a computer program for designing such a system. More particularly, the present invention relates to a technical field of describing a system using a highly abstract language such as the C language, e.g., a field called Electronic System Level (ESL) design.

2. Related Art

In recent years, for digital circuitry-based designs, attempts have been made to achieve design with higher productivity than using conventional hardware description languages by means of a highly abstract language, such as the C language or similar languages including SystemC™ and SpecC languages. Many electronic systems are composed of functional modules, such as CPUs and memory, and communication buses responsible for communication between such modules. Especially designs using the SystemC™ or SpecC language often utilize a concept of functional modules and channels connecting between them because an electronic system is designed with a higher level of abstraction. A design based on functional modules and channels subsequently requires a task called “design refinement”, which is manual replacement of the design with a configuration that uses communication buses. A development environment called System-on-Chip Environment (SCE) and the like, developed at the University of California at Irvine, U.S., conducts this task semi-automatically (reference may be made to the university's Center for Embedded Computer Systems Technical Report: TR03-45).

However, whether the conversion is done automatically with a tool or manually, it is not easy for design description after refinement to guarantee the original specifications. Besides, if design description is modified after design refinement, the design before and after the refinement will lose identity, which makes it even more difficult to verify whether the design after the refinement satisfies the original specifications.

Meanwhile, many designs of LSIs and the like, especially ones that use a hardware description language, adopts a method that uses a property description language based on temporal logic and/or regular expression to describe properties (constraints that should be met by the design of interest) and uses the properties for verifying design description. Property description languages as called herein include “Property Specification Language” (IEEE1850) and other like languages.

Goguen and Burstall, or Fiadeiro et al. have algebraically defined specification languages for describing parallel software and provided mathematical frameworks for synthesizing specifications of multiple software programs that run in parallel in those languages, as disclosed in Non-patent Documents 1 and 2 below.

[Non-patent Document 1]: Joseph A. Goguen and Rod M. Burstall. Institutions: abstract model theory for specification and programming. J. ACM, 39(1):95.146, 1992.
[Non-patent Document 2]: Jos'e Luiz Fiadeiro and Tom Maibaum. Categorical semantics of parallel program design. Sci. Comput. Program., 28(2-3):111.138, 1997.

### SUMMARY OF THE INVENTION

According to an aspect of the present invention, there is provided with a designing apparatus, comprising:

an input accepting unit configured to accept an input of
design description which describes a design of a system that includes
   a plurality of components and
   a plurality of channels each of which connects between components communicating with each other;
component constraint description which describes constraints that should be met by respective components; and
channel constraint description which describes constraints that should be met by respective channels;

a connection constraint description calculator configured to calculate connection constraint description which describes constraints that should be met between components connected by each channel, according to the design description, the component constraint description and the channel constraint description inputted to the input accepting unit:

a second input accepting unit configured to accept an input of communication constraint description describing a constraint pertaining to communication medium or communication protocol to be used in the system;

an overall constraint description calculator configured to calculate overall constraint description which describes constraints that should be met between all of the components, according to the connection constraint description and the communication constraint inputted to the second input accepting unit.

According to an aspect of the present invention, there is provided with a designing method, comprising:

accepting an input of
design description which describes a design of a system that includes
   a plurality of components and
   a plurality of channels each of which connects between components communicating with each other;
component constraint description which describes constraints that should be met by respective components; and
channel constraint description which describes constraints that should be met by respective channels;

calculating connection constraint description which describes constraints that should be met between components connected by each channel, according to the design description, the component constraint description and the channel constraint description inputted:

accepting an input of communication constraint description describing a constraint pertaining to communication medium or communication protocol to be used in the system; and

calculating overall constraint description which describes constraints that should be met between all of the components, according to the connection constraint description and the communication constraint description inputted.

According to an aspect of the present invention, there is provided with a computer readable media storing a computer program for causing a computer to perform instructions to execute the steps of:

accepting an input of
design description which describes a design of a system that includes
   a plurality of components and
   a plurality of channels each of which connects between components communicating with each other;
component constraint description which describes constraints that should be met by respective components; and
channel constraint description which describes constraints that should be met by respective channels;

calculating connection constraint description which describes constraints that should be met between components connected by each channel, according to the design description, the component constraint description and the channel constraint description inputted:

accepting an input of communication constraint description describing a constraint pertaining to communication medium or communication protocol to be used in the system; and

calculating overall constraint description which describes constraints that should be met between all of the components, according to the connection constraint description and the communication constraint description inputted.

### BRIEF DESCRIPTION OF THE DRAWINGS

FIG. 1 is a block diagram showing the overall configuration of a designing apparatus as an embodiment of the present invention;

FIG. 2 is a flowchart illustrating the flow of processing by the designing apparatus of FIG. 1;

FIG. 3 shows an example of an electronic system that is to be designed by the embodiment;

FIG. 4 shows an example of design description;

FIG. 5 shows exemplary meta-constraints;

FIG. 6 shows an example of component (custom component) properties;

FIG. 7 shows an example of a component (standard component) property;

FIG. 8 shows an example of channel properties;

FIG. 9 shows an example of logical expressions of communication properties (buses);

FIG. 10 is a flowchart illustrating the flow of connection property calculation;

FIG. 11 is a flowchart illustrating the flow of composite property calculation;

FIG. 12 shows an example of a diagram pertaining to connection property calculation;

FIG. 13 shows an example of connection morphism assignment;

FIG. 14 shows an example of calculating connection properties;

FIG. 15 shows an example of connection properties;

FIG. 16 shows an example of information on replaced signal in connection properties;

FIG. 17 shows an example of a diagram pertaining to composite property calculation;

FIG. 18 shows an example of calculating composite properties;

FIG. 19 shows an example of composite properties (before replacement);

FIG. 20 shows an example of composite properties (after replacement);

FIG. 21 shows an example of optimization rules;

FIG. 22 shows exemplary constraints on a CPU 1 resulting from the composite properties of FIG. 20;

FIG. 23 shows an example of a diagram for a communication property;

FIG. 24 shows an example of a communication constraint;

FIG. 25 shows an example of composite morphisms in communication properties;

FIG. 26 shows an example of information on replaced signals in composite properties;

FIG. 27 shows an example of optimization rules;

FIG. 28 illustrates the definition of “colimit”; and

FIG. 29 illustrates the definition of “colimit”.

### DETAILED DESCRIPTION OF THE INVENTION

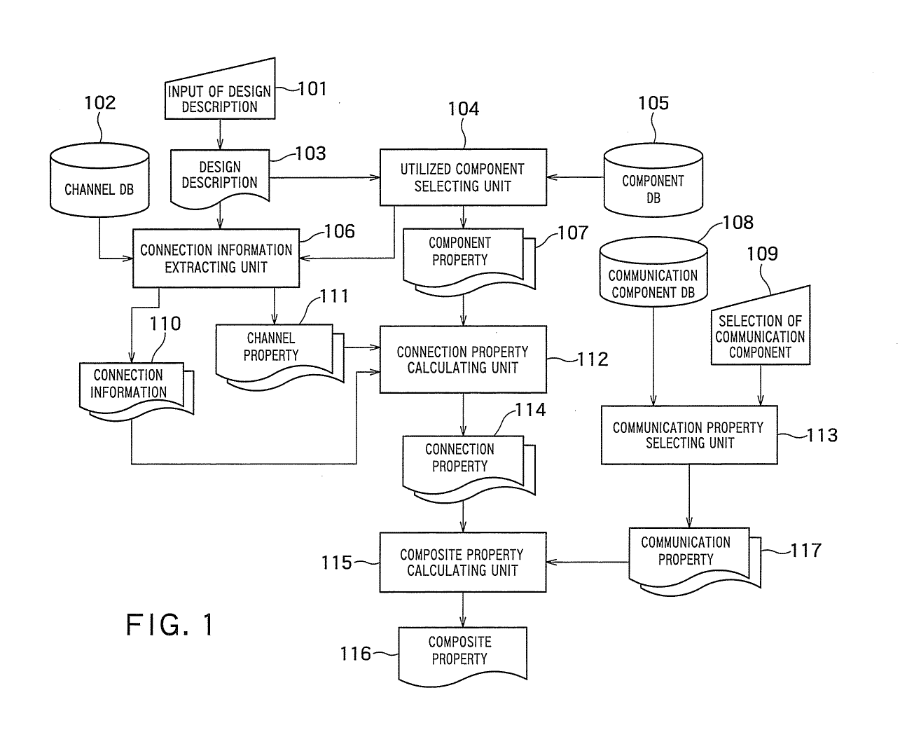

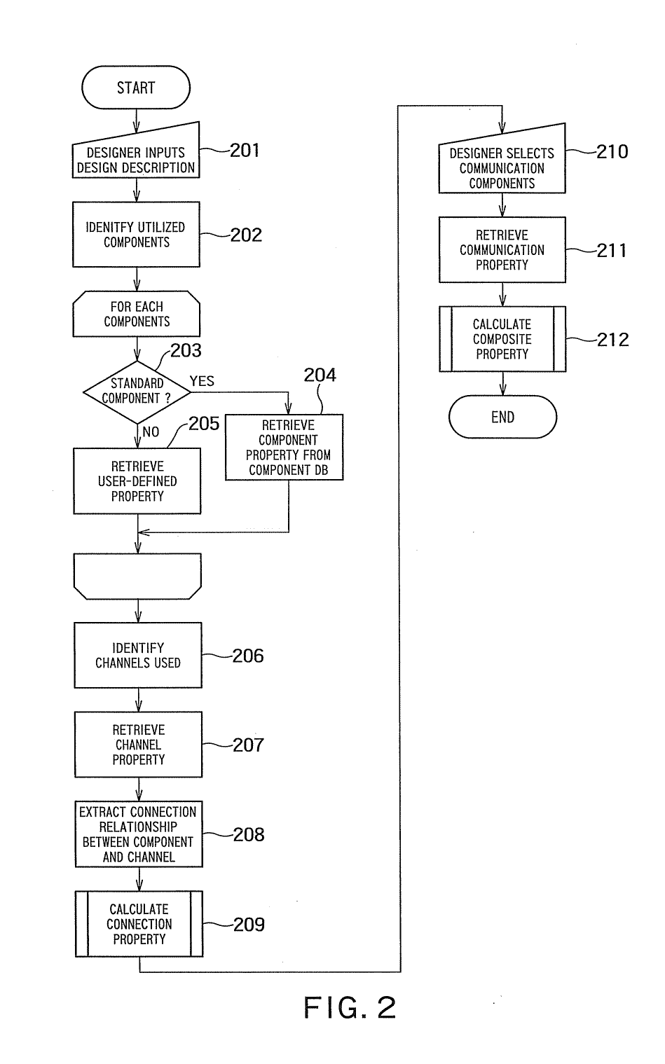

FIG. 1 is a block diagram showing the overall configuration of a designing apparatus as an embodiment of the present invention. FIG. 2 is a flowchart illustrating the flow of processing by the designing apparatus of FIG. 1. The functions of elements of the designing apparatus shown in FIG. 1 may also be realized by having a computer to execute a computer program that describes instructions for executing processing at each step shown in the flowchart of FIG. 2. The computer program may be stored on a recording medium, such as a hard disk or a CD-ROM, and read by the computer for execution. The flow of the processing will be generally described below with respect to FIGS. 1 and 2.

The apparatus first receives design description 103 based on input 101 from a designer (201 in FIG. 2). The description 103 describes a design of an electronic system in such a manner that a plurality of components are connected with each other through channels, as illustrated in FIG. 4, for example. The apparatus includes an input accepting unit which accepts an input of the design description.

A utilized component selecting unit 104 performs processing 202 for identifying utilized components that are described in the design description 103, and determines 203 whether each of the utilized components is a standard component stored in a component DB (database) 105. If the determination results in YES, the utilized component selecting unit 104 retrieves 204 a component property corresponding to the component (i.e., a standard component) from the component DB 105, and if NO, it directly reads a component property corresponding to the component (a custom component originally designed by the user) from the design description 103 (205). The component property is description of a constraint that should be met by components, and represents component constraint description. The utilized component selecting unit 104 may include a function of the input accepting unit accepting an input the component constraint description. The component DB 105 represents a second database, and the utilized component selecting unit 104 includes a component constraint description retriever. Processings from 203 through 205 described above are performed to all components identified.

Then, a connection information extracting unit 106 reads connection relationships between the components from the design description 103, and identifies 206 channels used in those connections. Then, the connection information extracting unit 106 retrieves a channel property 111 corresponding to each of the identified channels from a channel DB 102 (207). The channel property 111 is description of a constraint which should be met by channels and represents channel constraint description. The connection information extracting unit 106 may include a function of the input accepting unit accepting an input the channel constraint description. The channel DB 102 represents a third database, and the connection information extracting unit 106 includes a channel constraint description retriever. The connection information extracting unit 106 identifies through processing 208 the connection relationships between the channels identified by the processing 206 and the components identified by the utilized component selecting unit 104 to obtain connection information 110.

A connection property calculating unit 112 then performs calculation 209 of a connection property to obtain a connection property 114. The connection property is description of a constraint that should be met between components that are connected by the same channel, and represents connection constraint description.

After or independently of the processing at 209, the designer selects 109 a component (or medium) for communication (e.g., a bus of a certain type) (210). The selection 109 of the communication component (or communication medium) corresponds to an operation of specifying a communication component (or communication medium) or a communication protocol by the designer using a specifying unit.

A communication property selecting unit 113 obtains a communication property 117 corresponding to the communication component (or communication medium) selected by the designer from a communication component DB (or communication medium DB) 108 (211). The communication property is description of a constraint pertaining to a communication component (or communication medium) or a communication protocol to be used in the system (i.e in communication between components), and represents communication constraint description. The communication property selecting unit 113 represents a second input accepting unit and a communication constraint description retriever, and the communication component DB 108 represents a first database.

Then, a composite property calculating unit 115 calculates 212 a composite property from the connection property 114 and communication property 117 to obtain a composite property 116, which is output from the apparatus. The composite property is description of a constraint that should be met between all components that communicate via a communication component (or communication medium) or a communication protocol, representing overall constraint description. The composite property calculating unit 115 represents an overall constraint description retriever.

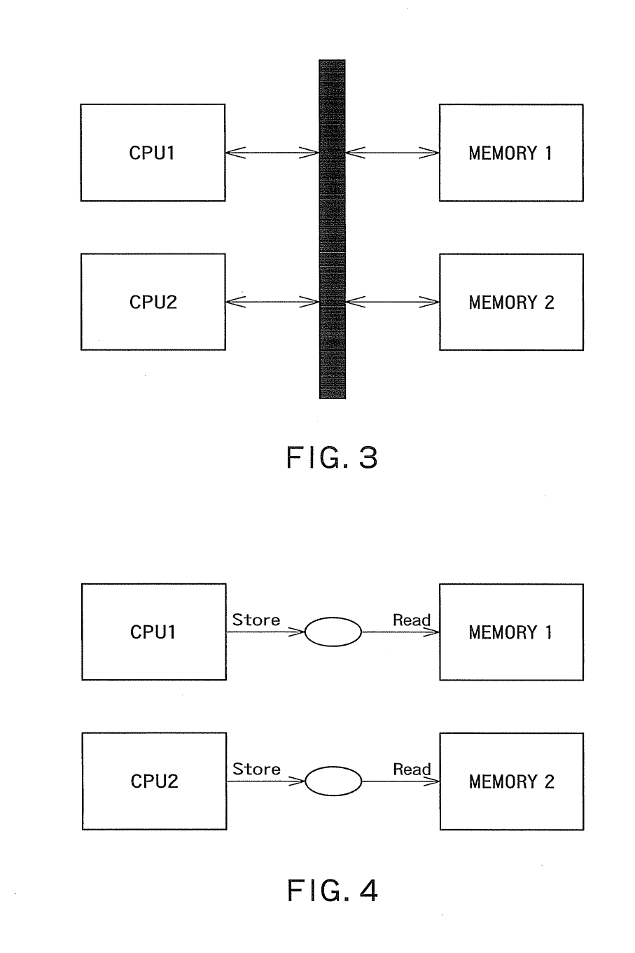

By way of illustration, suppose a case where an electronic system in which two CPUs and two memories communicate with one another via a single bus, such as shown in FIG. 3, is to be finally designed. The flow of processing by the apparatus will be described with respect to this example.

As input to the apparatus, the designer gives design description in which two pairs of a CPU and memory respectively communicate with one another through a channel, such as one shown in FIG. 4. A CPU 1 connects Store signal to the sending side of the channel and memory 1 connects Read signal to the receiving side of the channel. Consequently, when the CPU 1 issues Store signal, the signal is transmitted to the memory 1 through the channel. The same assumption is made for the CPU 2 and memory 2. That is, the design allows the CPU 1 to communicate only with the memory 1 and the CPU 2 only with the memory 2, enabling the pairs to operate in parallel.

It is assumed that the CPUs are prepared by the user as custom components and the memory is given in a DB as a standard component. Although the assumption here is that the two CPUs, memories, and channels are of the same and only a single type, there may be multiple types of channels, of course.

Properties stored in DBs (i.e., component, channel, and communication properties) are described by logical expressions that use temporal logic. Suppose that operators representing temporal logic, “F”, “X”, and “G” can be used, in addition to the general symbols of classical logic, “ [symbol] ” (logical product), “ [symbol] ” (logical sum), “→” (inclusion), and “ [symbol] ” (negation). Here, “FA” means “A will hold at some time”, “XA” means “A will hold at the next time”, and “GA” means “A holds all the time”. Although these operators sometimes use different symbols, they are general as temporal logic.

It is also assumed that [n] (n being a natural number) can also be used as a way of abbreviating consecutive “X”s. For instance, “[3]A” is synonymous with “XXXA”.

Hereinafter, “at the next time” will be read as “after one cycle”. “[N]A” means “A will hold after n cycles”. Also, regarding “A” as a signal in an electronic system, “A holds” can be read as “signal ‘A’ becomes 1” or “signal ‘A’ is asserted”. Conversely, “A does not hold” can be read as “signal A becomes 0” or “signal ‘A’ is deasserted”.

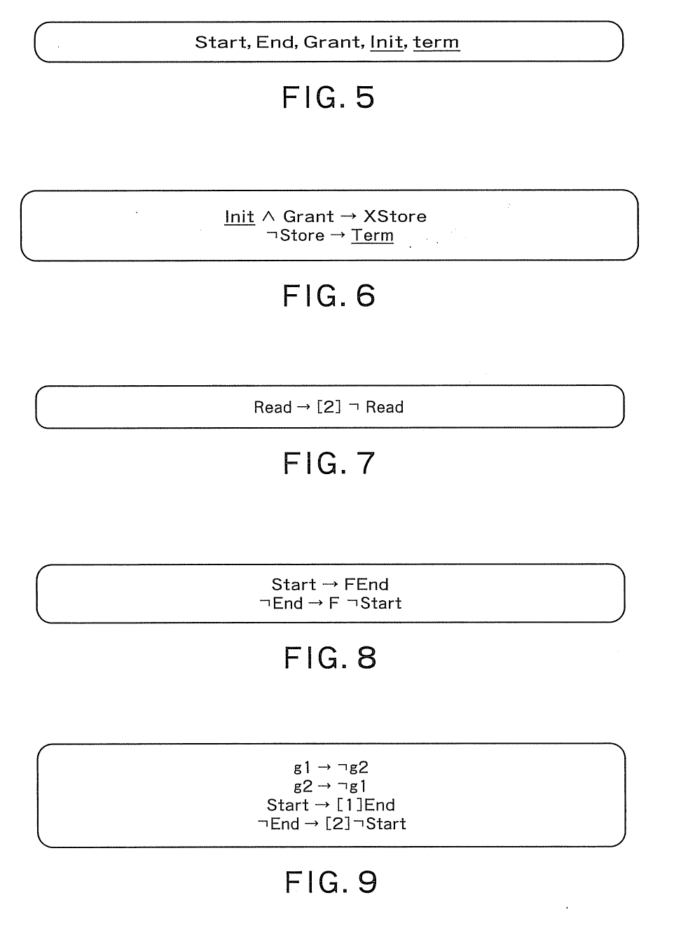

Additionally, properties stored in the DBs are described in accordance with meta-constraints which are given as illustrated in FIG. 5. The role and usage of meta-constraints will be described below. In the example of FIG. 5, meta-constraints are made up of the following symbols:
Signal “Start” that represents an end point on the sending side of a channel
Signal “End” that represents an end point on the receiving side of the channel
Signal “Grant” that indicates a status of whether transmission to a channel is possible
Pseudo signal “Init” that represents start of computation and
Pseudo signal “Term” that represents end of computation.

The meta-constraints show signals that are used in communication properties and connection properties in common (symbols as units of communication). The channel property is described by a logical expression that uses signals described in meta-constraints as mentioned above, whereas the component property can also use signal names other than signals described in the meta-constraints. The communication property is made up of three elements: communication constraints which are defined independently of meta-constraints, a logical expression that uses signals described in the communication constraints, and a composite morphism that relates a signal described in the communication constraints with the name of a signal used in the connection property. The communication property is defined by a collection of multiple diagrams, e.g., one shown in FIG. 23.

Suppose the designer gives such properties as shown in FIG. 6 to a CPU. For the sake of brevity, assume that the CPU maintains only Store instruction, and regarding the instruction as one signal, the simplest constraints are given to the CPU.

The logical expression shown in the first line is a constraint indicating that “computation starts, and if transmission to a channel is possible at that time, Store signal will be asserted at the next cycle”, and the logical expression in the second line means that “when Store signal has become 0, the computation finishes”.

Suppose the apparatus stores the property of FIG. 7 in the component DB 105 as a memory property and the properties of FIG. 8 in the channel DB 102 as channel properties. The logical expression of FIG. 7 means “if Read signal has become 1, Read signal will become 0 after two cycles”. The first line of FIG. 8 means “if Start signal has become 1, End signal will become 1 at some time, and the second line means “if End signal has become 0, Start signal will become 0 at some time”.

Upon receiving input of such design description as shown in FIG. 4, the apparatus retrieves properties of the CPUs, memory, and channels from appropriate DBs or the design description. The apparatus then analyzes that the CPU and the channel are connected at the Start portion and the memory and the channel are connected at the End portion. Then, the connection property is calculated by the connection property calculating unit 112.

Calculation of the connection property and composite property, which will be discussed below, is actually processing for calculating “colimit” as called in the category theory in mathematics. To discuss the calculation of the connection property, the definition of “colimit” is first cited from Definition 5.3.7 of “Program Imiron (Program Semantics)”, Hirofumi Yokouchi (ISBN: 4-320-02657-8).

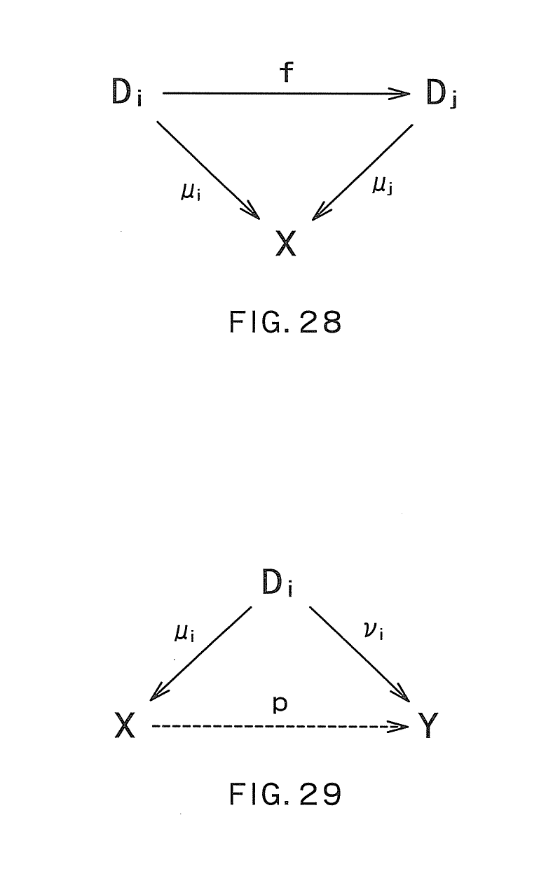

Suppose category “c” and its diagram “D” are given. For the object “X” of “C” and each vertex “i” of D, the morphism of “C”, μi:Di→X (“Di” being the morphism of “C” assigned to vertex “i”) has been defined, and the diagram of FIG. 28 commutes with respect to an arbitrary morphism within “D”, f:Di→Dj. Here, a tuple of families of “C”'s morphisms that are indexed by the object “X” and the set “V” of vertices of “D”, μ=(μi:Di→X)_{iεV}, is called “cone” from “D” (or sometimes called “cocone”) and represented as μ: D→X.

Furthermore, for an arbitrary “cone” from “D”, v:D→Y, a certain morphism p:X→Y exists, and the diagram of FIG. 29 commutes with respect to each vertex “i” of “D”, and also precisely one such morphism “p” is present. Here, “μ” is called the “colimit” of “D”.

The “morphism” is a term of category theory and corresponds to homomorphism of set theory. The equivalent for diagram “D” in the definition above is called “base”. A “vertex” refers to a position pointed by an arrow in a base.

Goguen and Burstall mentioned above have shown that composition of specifications in specification description can be determined by “colimit” which is defined based on a category made up of the specifications and morphisms defined between the specifications, and this theory is used for calculation of the connection and composite properties in the present apparatus. In short, determination of (object “X” included in) “colimit” in accordance with the above definition by appropriately setting a base is the processing performed by the connection property calculating unit 112 and composite property calculating unit 115. The two calculating units can be integrated in this respect, but they are specifically separately described in this specification.

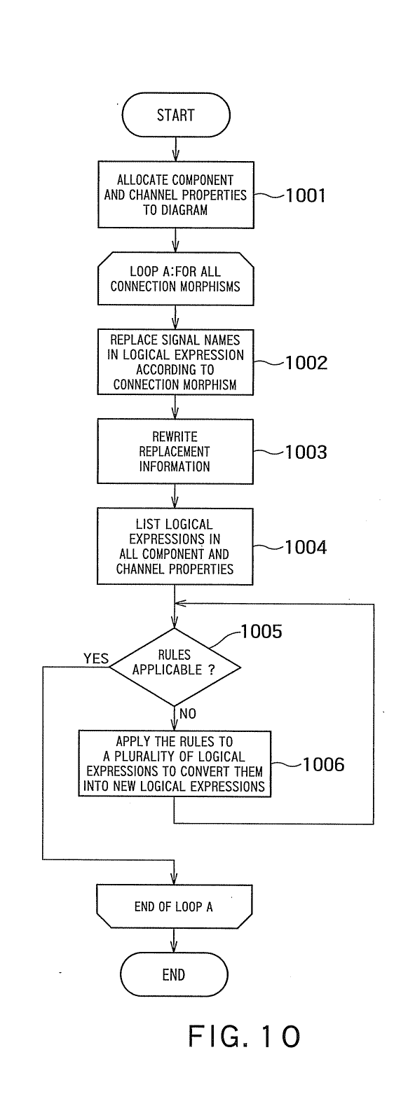

FIG. 10 is a flowchart illustrating the calculation of connection properties.

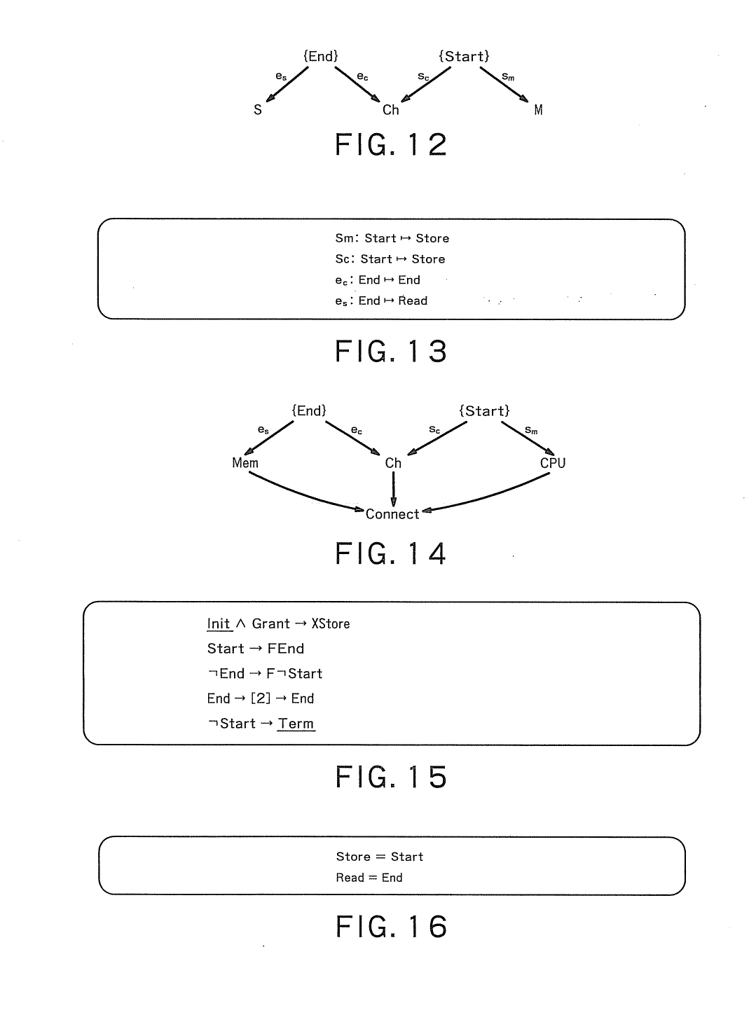

First, processing 1001 for allocating appropriate component and channel properties to a diagram is performed. A diagram representing a base for determining connection properties in accordance with the meta-constraints of FIG. 5 is the one shown in FIG. 12. “M” and “S” denote component properties, and “Ch” denotes a channel property. This figure means a component connected to the sending side (Start side) of a channel has property “M” and a component connected to the receiving side (End side) of the channel has property “S”. For example, to determine the connection property between the CPU 1 and the memory 1, CPU 1 is assigned to “M”, memory 1 to “S”, and “Ch” represents the channel between them.

Next, processing 1002 for replacing signal names used in component properties in accordance with connection relationships is performed. This replacement is equivalent to assignment of an appropriate connection relationship to the arrows (i.e., connection morphisms) in the above-mentioned diagram. For instance, morphisms in the diagram, “sₘ”, “s_{c}”, “e_{c}”, and “eₛ”, are defined as shown in FIG. 13 based on connection information analyzed by the connection information extracting unit 106. That is, for “sₘ”, “s_{c}”, “e_{c}”, and “eₛ” in FIG. 12, the assignment relationships shown in FIG. 13 are derived from the connection information. Specifically, since Store signal for the CPU 1 is connected to the sending side of the channel, Store signal is regarded as the same as Start signal (i.e., Start signal is assigned to Store signal). This is what morphism “sₘ” means. Similarly, since Read signal for the memory is connected to the receiving side of the channel, morphism “eₛ”, which means End signal is assigned to Read signal, is determined. The morphisms “s_{c}” and “e_{c}” are defined as identity morphisms (identity mappings) that regard Start signal for the channel as Start signal and End signal as End signal without requiring analysis information. In accordance with such assignment relationships, signal names used in component properties are replaced.

For a replaced signal, the assignment relationship between the signal before replacement and that after replacement is described as replacement information in accordance with processing at 1003.

Then, the connection property is obtained by performing processing 1004 for collectively listing and collecting logical expressions of all component and channel properties after signal name replacement. Calculation of the connection property is to determine “Connect” as illustrated in FIG. 14, and “Connect” is “colimit” that should be determined.

Furthermore, though the description hereinafter is not essential, when rules for converting logical expressions have been defined, e.g., ones shown in FIG. 27, determination 1005 is made as to whether it is possible to apply those rules to some of the logical expressions listed at 1004. In FIG. 27, rule “And1” provides that two expressions A→FB and A→XB can be replaced with one A→XB, and rule “And2” provides that two expressions A→FB and A→B can be replaced with one A→B. If the determination 1005 results in YES, conversion processing 1006 is performed to apply appropriate conversion rules to a plurality of logical expressions for which application has been determined to be possible to delete old logical expressions and generate new logical expressions, and then determination 1005 is made again. If determination 1005 results in NO, processing is terminated. When processing at 1005 and 1006 is not necessary, the rules are simply not defined.

Connection properties calculated in this example are shown in FIG. 15. At this point, the same properties are calculated entirely separately for the CPU 1 and memory 1, and the CPU 2 and memory 2. FIG. 15 shows only one of the two sets. Signal names that were used in the original component property have been replaced as shown in FIG. 16 in the connection properties. Such information (information on replaced signals in connection properties) may also be simultaneously output by the connection property calculating unit 112 and reflected in the result of composite property calculation which will be performed later.

From the result at this point, the designer may also obtain constraints pertaining to communication between modules at a phase where constraints pertaining to communication in the entire system, such as buses, are not introduced yet.

The designer next selects components associated with communication across the entire system, e.g., communication buses, such as by referencing the result above, and inputs the information to the apparatus. Suppose here that bus components having such communication properties as shown in FIGS. 9, 23, 24, and 25 are selected.

The communication property selecting unit 113 of the apparatus retrieves communication properties pertaining to the communication components selected by the designer from the communication component DB 108, and the composite property calculating unit 115 calculates composite properties from the communication and connection properties.

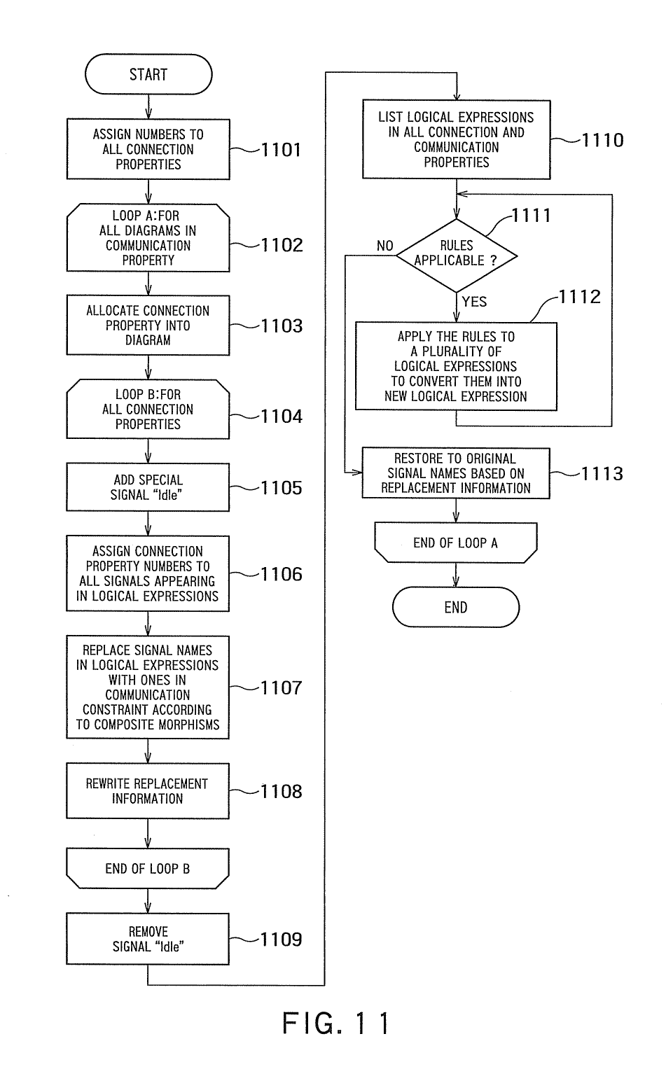

FIG. 11 is a flowchart illustrating the flow of composite property calculation.

First, processing 1101 for assigning numbers 1 through n to all of n connection properties as input is performed. Then, processing 1103 for allocating connection properties to one of diagrams included in the communication property is performed.

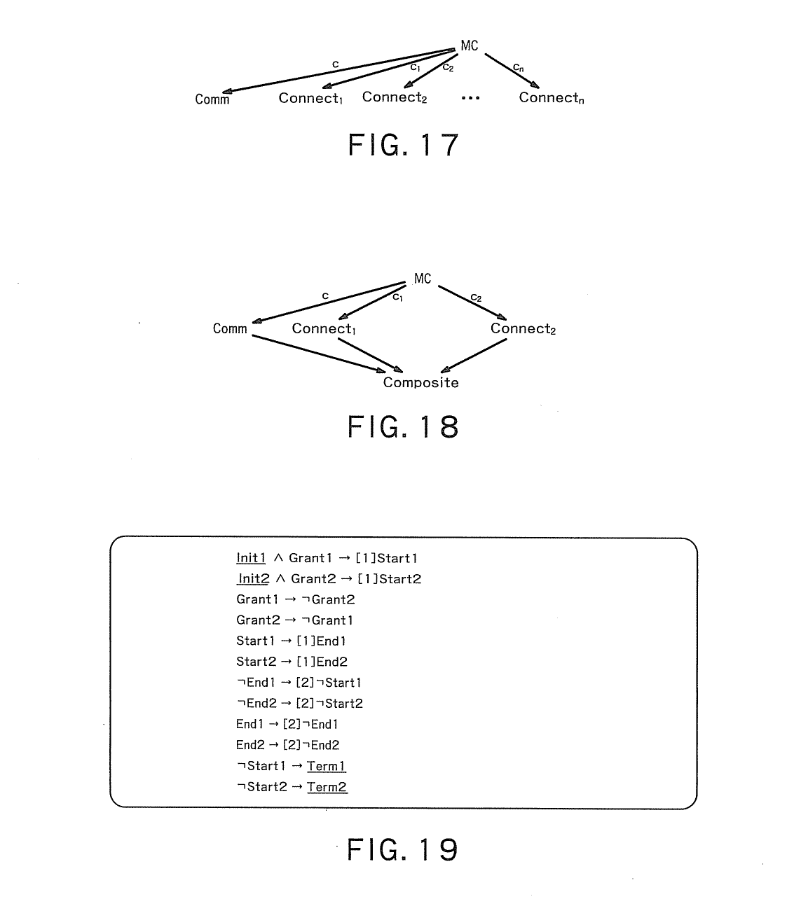

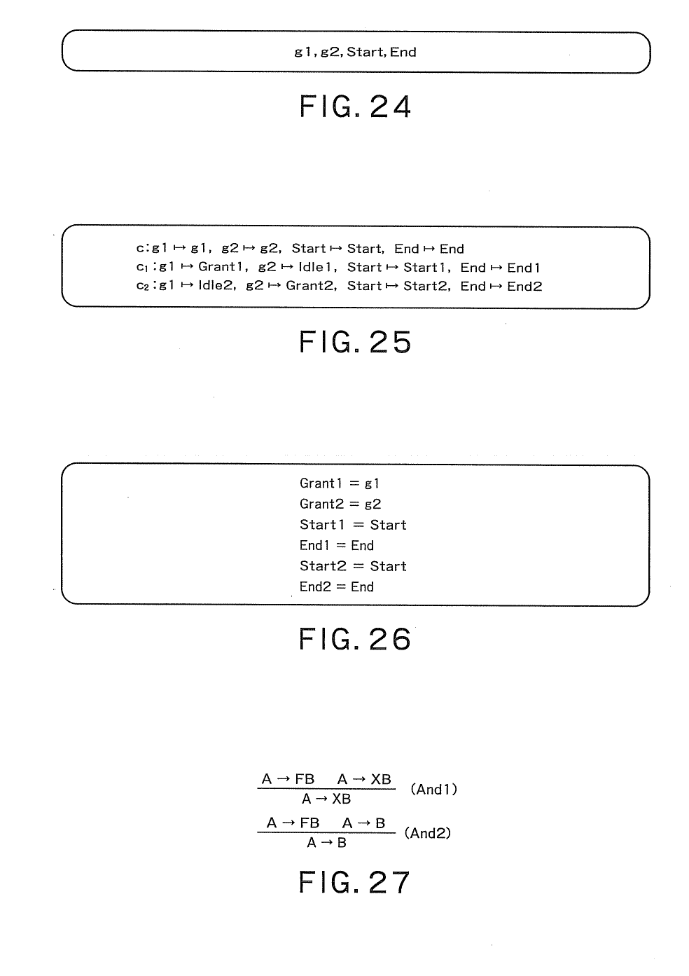

Here, a typical one of diagrams included in the communication property is the one shown in FIG. 17. In this diagram, “MC” denotes a communication constraint, “Comm” denotes a set of logical expressions described using the communication constraint, and “Connect₁”, . . . , “Connectₙ” denote multiple (n) connection properties that have been determined in the processing so far. Also, morphisms “c”, “c₁”, . . . , “cₙ” from “MC” to “Comm” and to “Connect₁”, . . . , “Connectₙ”, (i.e., composite morphisms) are morphisms that assign signals defined in the communication constraint to signals defined in meta-constraints, namely signals used in the connection properties. In this example, the communication property is represented by a single diagram that is made up of the combination of FIGS. 9, 23, 24 and 25. FIG. 23 shows the diagram in its entirety, FIG. 24 shows communication constraints “MC” in it, FIG. 9 shows logical expressions “Comm” which are described using the communication constraints, and FIG. 25 shows the definition of composite morphisms, “c₁”, . . . , “cₙ”. “Colimit” of FIG. 23, that is, “Composite” shown in FIG. 18, is the composite property that should be determined.

In the processing 1103, n connection properties are assigned to “Connect₁” to “Connectₙ” described above in accordance with the numbers assigned at 1101. In this example, there are two connection properties, each allocated to “Connect₁” and “Connect₂”. In this example, the contents of logical expressions included in the two properties are identical.

Then, processing is performed to each of the connection properties in accordance with iterative processing 1104. First, processing 1105 for adding special signal “Idle” to the connection property is performed. This means it is a signal not used in the logical expression of each connection property. This will be utilized in subsequent processing at 1107.

Then, processing 1106 for assigning the numbers allocated at 1101 to signal names in the connection property is performed. For instance, when “1” is assigned to a connection property, signal “Start” in that property is changed to “Start1”. This processing is for preventing conflict of signal names in case a signal of the same name is used in other connection properties.

Then, processing 1107 is performed for replacing signal names with ones defined in the communication constraint in accordance with the composite morphisms that are defined in the communication properties. Here, the communication constraint is given as shown in FIG. 24, for example, and the composite morphisms are given as shown in FIG. 25. In FIG. 25, “cᵢ” indicated on the left is the name of a composite morphism, and each of the expressions indicated with “→” that are listed on the right of colons denotes assignment of a signal name in the communication constraint to a signal name in the connection property (on the assumption that the signal name has been already changed in the processing 1106). The left side of “→” denotes the signal name in the communication constraint, and the right side denotes that in the connection property.

By applying composite morphism “cᵢ” to the ith connection property “Connectᵢ”, the signal name in the connection property can be replaced with that in the communication constraint. However, a signal name in a connection property that is not included in assignment defined in a composite morphism will not be replaced. Also, when assignment to “Idleᵢ” has been made in composite morphism “cᵢ”, actual assignment does not take place. This processing is utilized for a signal that is defined in the communication constraint and can be replaced in other connection properties but replacement does not take place in the connection property of interest.

Then, processing 1108 is performed for saving the change of signals before and after the replacement at 1107 as replacement information (composite property replaced signal information), as shown in FIG. 26, for example.

If signal “Idle” and equivalent symbols “Idle₁”, . . . , “Idleₙ” remain after performing the above processing to all connection properties, processing 1109 for deleting them is performed.

Then, processing 1110 is performed for listing and collecting logical expressions defined in all the connection and communication properties together.

If conversion rules such as shown in FIG. 27 (“And1” and “And2”) have been defined, determination 1111 is made as to whether those conversion rules can be applied to multiple ones of the logical expressions collected at 1110. If the determination results in YES, processing 1112 is performed for applying the conversion rules to logical expressions for which application has been determined to be possible to delete logical expressions before the application and generate new logical expressions. Thereafter, determination at 1111 is made again.

If determination at 1111 results in NO, processing 1113 is performed to restore signal names used in each logical expression to ones before the replacement done at 1107 based on the replacement information saved at 1108.

The processing described so far is repetitively performed to all diagrams included in the communication property (loop 1102). That is, when there are a number of diagrams in the communication property, calculation of composite property is applied to the result of calculation by processing 1110 through 1112 to compute a new result of calculation. This processing is repetitively applied to all diagrams in the communication property. When it has been applied to all the diagrams, this processing is terminated.

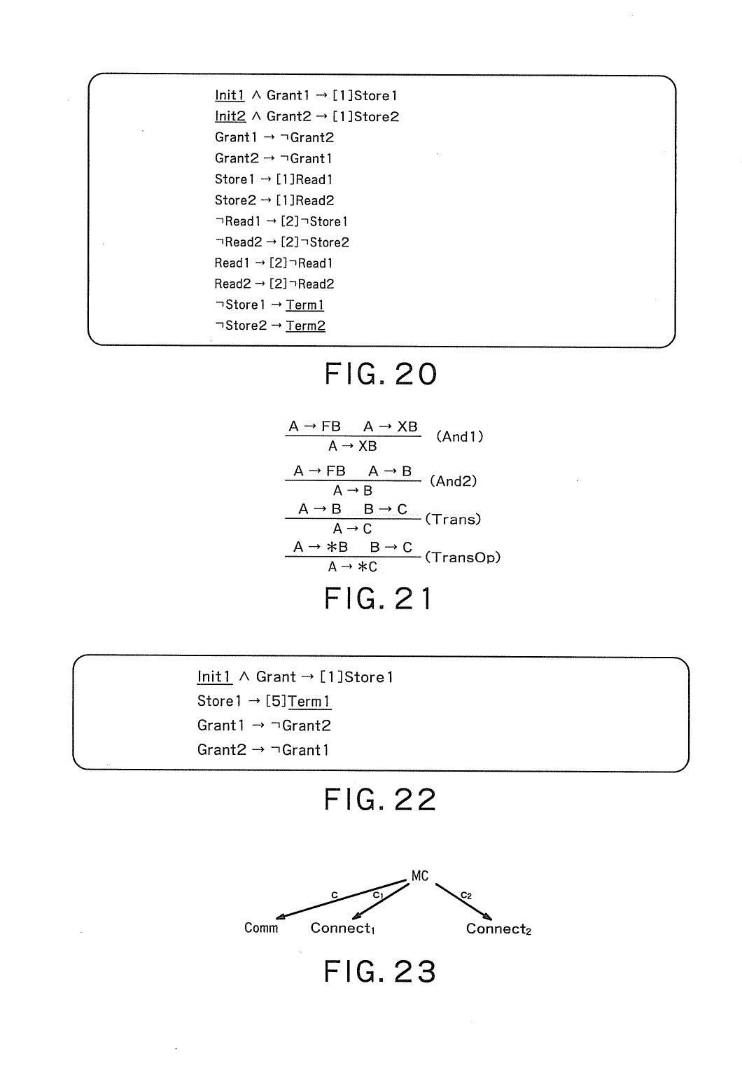

In this example, processing 1110 to 1112 provides composite properties shown in FIG. 19 which represent design constraints on the entire electronic system. Then, in processing 1113, by representing the composite properties of FIG. 19 using Store and Read signals, which were used in the component properties, with reference to the result of assignment at the time of connection property calculation shown in FIG. 16 (however, represented as “Store1” and “Store2”, and “Read1” and “Read2”, because “Start” and “End” use the same signal names in two connection properties, “Start1” and “Start2”, and “End1” and “End2”, respectively), the composite properties shown in FIG. 20 are produced.

Using the composite properties thus obtained, the designer can verify the design of the system or obtain various types of information. Here, as an example of their application, constraints on Store instruction of the CPU 1 will be calculated.

With respect to FIG. 20, logical expressions pertaining to the CPU 1, one of the two CPUs, are extracted. That is, the apparatus includes a component constraint extracting unit (not shown) for extracting constraints on a specific component from the composite properties (i.e., overall constraint description). By applying the rules shown in FIG. 21 to the extracted logical expressions pertaining to the CPU 1 a number of times, the logical expressions are simplified to logical expressions from symbols “Init1” to “Term1”, which denote the start and end points of a time series. However, an arbitrary temporal operator fits into “*” in the rule “TransOp”.

The result is shown in FIG. 22. From these logical expressions, the following constraint conditions can be read:
Grant signal has to be true in order for Store instruction to be asserted to finish computation. However, the Grant signal is not asserted concurrently with Grand signal to the other CPU. That is to say, Store instruction for the CPU 1 and Store instruction for the CPU 2 have to be mutually exclusively asserted.
It takes five cycles from the assertion of Store instruction to the termination thereof.

Although this is just human interpretation, by utilizing these properties on a verification device for a CPU and software running thereon, for example, verification in units of software instructions can be conducted.

On the other hand, although embodiments contemplated by the present invention are mainly for designing electronic systems such as LSIs, they may be also utilized for designing a distributed system in which a number of computing devices communicate with each other via a network, for instance. Constraints that should be met by each of the computing devices (components of the distributed system) are given in the form of component properties and/or custom properties created by the designer, and constraints pertaining to communication with individual communication parties are given in the form of channel properties. Then, a communication protocol (may include a network topology) and the like are given as the communication property of the entire system.

In this manner, constraint specifications for the entire system can be derived by this apparatus using as inputs each computing device, communication-related specifications separately given to each computing device, and selection of a communication protocol.

As has been described above, according to the embodiment of the invention, by representing not only design components but properties corresponding to them as components, reusing them, and automatically compositing properties in the course of design refinement, the designer can obtain the properties of the entire system (composite properties) after design refinement efficiently and with a reduced workload. The designer can utilize the composite properties to easily verify whether the refined design description actually satisfies constraints.

In addition, as the designer can handle the design of an entire system dividing it into:
respective modules and individual communication between them, and
selection of communication pertaining to the entire system, the designer can obtain system constraints more abstractly and simply without being troubled by communication constraints of the entire system from the start of designing.

Moreover, the scheme proposed by the invention can enhance re-usability of properties and enable efficient reuse, and it also enables characteristics that cannot be checked on a per-component basis to be checked from connection relationship between components and/or combination with communication properties.

What is claimed is:

1. A designing apparatus, comprising:
an input accepting unit configured to accept an input of
design description which describes a design of a system that includes
a plurality of components and
a plurality of channels each of which connects between components communicating with each other;
component constraint description which describes constraints that should be met by respective components; and
channel constraint description which describes constraints that should be met by respective channels;
a connection constraint description calculator configured to calculate connection constraint description which describes constraints that should be met between components connected by each channel, according to the design description, the component constraint description and the channel constraint description inputted to the input accepting unit:
a second input accepting unit configured to accept an input of communication constraint description describing a constraint pertaining to communication medium or communication protocol to be used in the system;
an overall constraint description calculator configured to calculate overall constraint description which describes constraints that should be met between all of the components, according to the connection constraint description and the communication constraint inputted to the second input accepting unit.

2. The apparatus according to claim 1, wherein the component constraint description, the channel constraint description and the communication constraint description are described by logical expressions based on temporal logic.

3. The apparatus according to claim 1, comprising:
a first data base configured to store communication constraint description associated with identification information of the communication medium or the communication protocol;
a specifying unit configured to specify communication medium or communication protocol to be used in the system; and
a communication constraint description retriever configured to retrieve communication constraint description associated with the communication medium or the communication protocol specified by the specifying unit, from the first database and input retrieved communication constraint description to the second input accepting unit.

4. The apparatus according to claim 1, comprising:
a second database configured to store component constraint description associated with identification information of each component;
a third database configured to store channel constraint description associated with identification information of each channel;
a component constraint description retriever configured to retrieve component constraint description associated with each component described in the design description from the second database and input retrieved component constraint description to the input accepting unit; and
a channel constraint description retriever configured to retrieve channel constraint description associated with each channel described in the design description from the third database and input retrieved channel constraint description to the input accepting unit.

5. The apparatus according to claim 1, further comprising a component constraint extracting unit configured to extract a constraint on a specific component from the overall constraint description.

6. A designing method, comprising:
accepting an input of
design description which describes a design of a system that includes
a plurality of components and
a plurality of channels each of which connects between components communicating with each other;
component constraint description which describes constraints that should be met by respective components; and
channel constraint description which describes constraints that should be met by respective channels;
calculating connection constraint description which describes constraints that should be met between components connected by each channel, according to the design description, the component constraint description and the channel constraint description inputted:
accepting an input of communication constraint description describing a constraint pertaining to communication medium or communication protocol to be used in the system; and
calculating overall constraint description which describes constraints that should be met between all of the components, according to the connection constraint description and the communication constraint description inputted.

7. The method according to claim 6, wherein the component constraint description, the channel constraint description and the communication constraint description are described by logical expressions based on temporal logic.

8. The method according to claim 6, comprising:
providing a first data base which stores communication constraint description associated with identification information of the communication medium or the communication protocol;
specifying communication medium or communication protocol to be used in the system; and
retrieving communication constraint description associated with the communication medium or the communication protocol specified, from the first database and inputting retrieved communication constraint description.

9. The method according to claim 6, comprising:
providing a second database which stores component constraint description associated with identification information of each component;
providing a third database which stores channel constraint description associated with identification information of each channel;
retrieving component constraint description associated with each component described in the design description from the second database and inputting retrieved component constraint description; and
retrieving channel constraint description associated with each channel described in the design description from the third database and inputting retrieved channel constraint description.

10. The method according to claim 6, further comprising, extracting a constraint on a specific component from the overall constraint description.

11. A computer readable media storing a computer program for causing a computer to perform instructions to execute the steps of:
accepting an input of
design description which describes a design of a system that includes
a plurality of components and
a plurality of channels each of which connects between components communicating with each other;
component constraint description which describes constraints that should be met by respective components; and
channel constraint description which describes constraints that should be met by respective channels;
calculating connection constraint description which describes constraints that should be met between components connected by each channel, according to the design description, the component constraint description and the channel constraint description inputted:
accepting an input of communication constraint description describing a constraint pertaining to communication medium or communication protocol to be used in the system; and
calculating overall constraint description which describes constraints that should be met between all of the components, according to the connection constraint description and the communication constraint description inputted.
